(19) United States
(12) Patent Application Publication
(10) Pub. No.: US 2003/0212581 A1
(43) Pub. Date: Nov. 13, 2003

(54) Method and apparatus for capturing medical information

(76) Inventors: Susan Adolph, London (CA); R.B. Bourne, London (CA); B. Chesworth, London (CA); Arjo Soer, London (CA); Gerard Stafleu, London (CA); Michael W. Clarke, Komoka (CA)

Correspondence Address: Orenge & Chari, Suite 4900, P.O. Box 190, 66 Wellington St. W., Toronto, Ontario M5K 1H6, ON, CA

(21) Appl. No.: 10/143,758

(22) Filed: May 14, 2002

(30) Foreign Application Priority Data
May 13, 2002 (CA) 2,386,060

(51) Int. Cl. G06F 17/60

(52) U.S. Cl. 705/3

(57) ABSTRACT

The present invention is directed at a method of capturing medical information. Capturing medical information concerning patients is an important task for medical practitioners because the information generally allows the practitioners to track their patient's medical history. However, depending on individuals to manually record medical information such as replacement part codes, may result in human error. In order to reduce the chance of human error, a PDA scanner is used to scan and store the medical information into a PDA. The scanned information may then be immediately entered into a medical information record corresponding to the patient undergoing surgery.

### BACKGROUND OF THE INVENTION

1. Field of the Invention

The present invention relates in general to data capture and more specifically to a method and apparatus for capturing medical information.

2. Description of the Prior Art

It has been well established that medical practitioners are required to maintain records or patients in order to keep track of the patient's medical history. These records generally include various information concerning the patient, such as name, address, health card number along with past injuries or illnesses. The capture of such information has generally been via answered questionnaires or written records obtained by the medical practitioner during appointments with the patient. This information is then stored in a file or manually entered into a computer to be stored into a central database.

When medical practitioners perform medical procedures, such as joint replacement surgery, the tracking of replacement parts after they have been surgically implanted into a patient is important. If a device manufacturer recalls a defective replacement part, medical practitioners need such information to identify which patients have had the defective replacement part implanted and may require surgery to remove and replace the defective part. Having all of the information readily available from the central database facilitates identifying a patient with a defective replacement part. In this manner, the list of patients may be quickly generated and the patients notified of the requirement for them to have a consultation with their medical practitioner.

Presently, the retrieval of the replacement part information is via a check of stickers located within the patient's medical file. These stickers are taken from the packaging of the replacement parts. This is quite time consuming and it may be possible that stickers may be lost as well.

It is an object of the present invention to obviate and mitigate the above disadvantages.

### SUMMARY OF THE INVENTION

In an aspect of the present invention, there is provided a method of capturing medical information associated with a patient experiencing a medical procedure comprising the steps of storing a first set of information relating to the patient on a PDA; scanning and storing a second set of information generated during the medical procedure on the PDA; and associating the second set of information with the first set of information and storing the first and second sets of information in a medical information record.

In another aspect, there is provided a method of capturing medical information using a PDA having pre-stored patient information comprising the steps of scanning replacement part information associated with the patient with the PDA; and storing the replacement part information with the patient information in the medical information record.

In yet another aspect, there is provided a method of capturing medical information comprising the steps of storing non-scannable information onto a PDA in the form of a medical information record; scanning and storing scannable information to the medical information record; and uploading the medical information record from the PDA to a central database.

### BRIEF DESCRIPTION OF THE DRAWINGS

These and other features of the preferred embodiments of the invention will become more apparent in the following detailed description in which reference is made to the appended drawings wherein:

FIG. 1 is a schematic diagram of an embodiment of a system for capturing medical information;

FIG. 2 is a flowchart showing an embodiment of a method for capturing medical information;

FIGS. 3a to 3i are screen shots;

FIG. 4a is a schematic diagram of a log on page;

FIG. 4b is a screen shot of an uploading menu page;

FIG. 4c is a screen shot of an uploading status page;

FIG. 5 is an outline of a data check file; and

FIG. 6 is a flowchart showing a second embodiment of the method for capturing medical information.

### DESCRIPTION OF THE PREFERRED EMBODIMENTS

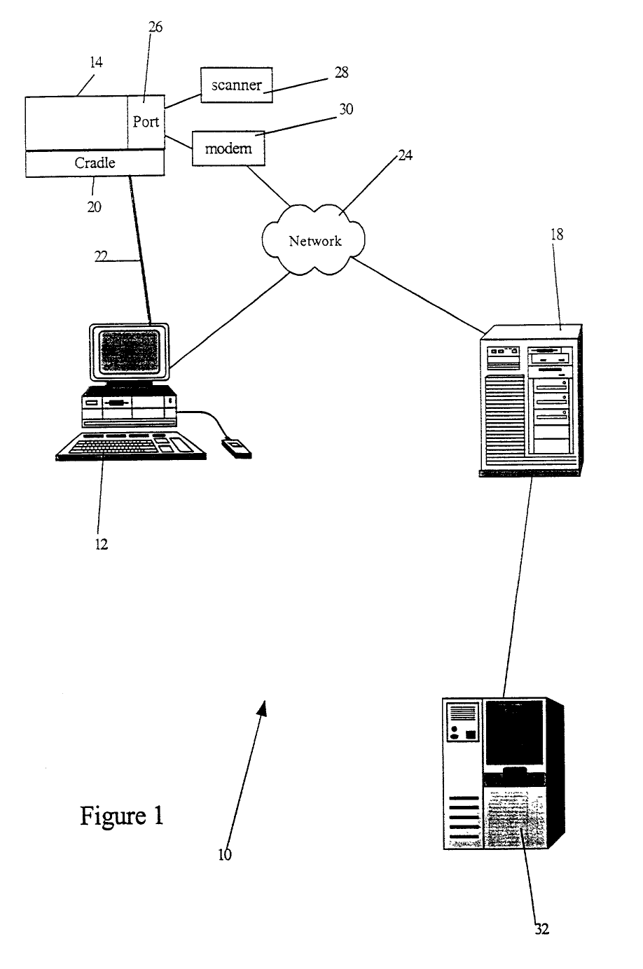

Turning to FIG. 1, an embodiment of a system for capturing medical information is shown. The system 10 includes a computer 12, a personal digital assistant (PDA) 14 and a web server 18. A PDA 14 is simply a small mobile hand-held device that provides computing and information storage and retrieval capabilities. The computer 12, such as a desktop computer or a laptop, is preferably used to create and store medical information records in a medical information record database and is associated with a single practitioner and single PDA 14. The medical information records are records which include patient (demographic and consultation) and operation (replacement part and surgery) information. The computer 12 communicates with the PDA 14 and the web server 18 to transfer the medical information records. Communication between the computer 12 and the PDA 14 is facilitated via a serial or USB cradle 20 and cable 22, operation of which will be well known to one skilled in the art, while communication between the computer 12 and the web server 18 preferably occurs over a network 24 such as the Internet or an intranet. The connection between the computer 12 and the network 24 is via an Ethernet or dial-up connection.

The PDA 14 also includes a port 26 for housing PDA peripherals such as a scanner 28 to scan information or a modem 30 to facilitate communication with the web server 18. It will be understood that the port 26 may house only one peripheral at a time in which case, the modem 30 and scanner 28 may not be used simultaneously. When required, the scanner 28 is inserted into the port 26 so that the PDA 14 may function as a scanner to scan bar codes containing replacement part information. The modem 30 is inserted into the port 26 and used to connect the PDA 14 to the network 24 via a dial-up connection to facilitate communication between the PDA 14 and the web server 18 to upload or retrieve medical information records.

The web server 18 provides a central database whereby medical information records from various PDAs 14 and computers 12 may be stored prior to verification. The medical information records are preferably uploaded to the web server 18 from the computer 12, but stay also be uploaded from the PDA 14. The web server 18 hosts a web site which is accessed by the medical practitioner (via the PDA 14 or computer 12) which facilitates the transmission of the medical information records as will be described below.

The system 10 may farther include a secure database 32, such as an Oracle database, to securely store verified medical information records which are transferred from the web server 18. The secure database 32 provides an increase in privacy and security for the medical information records. After the medical information records are stored in the central database of the web server 18, they are processed and transferred to the secure database 32.

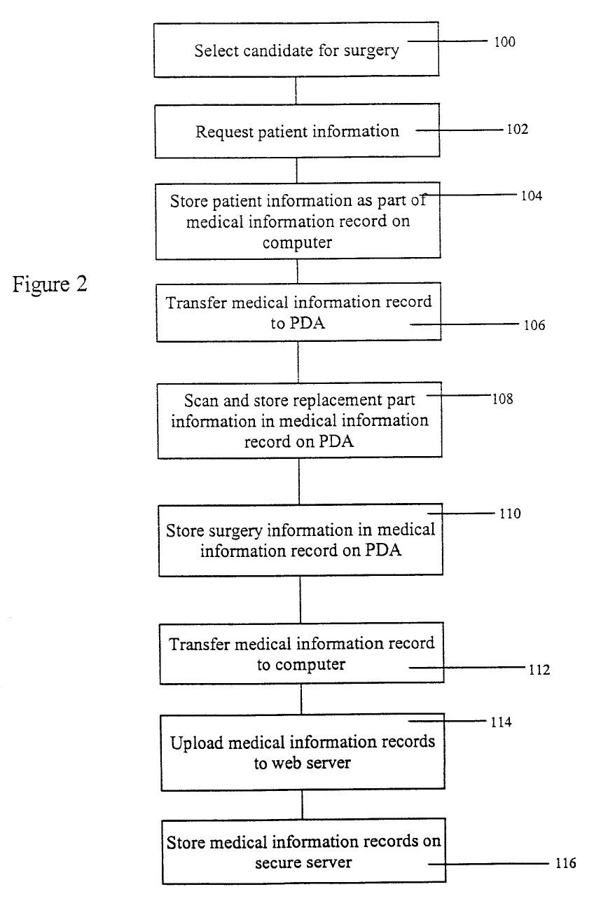

Turning to FIG. 2, a flowchart illustrating an embodiment of a method of capturing medical information in a medical procedure is shown. Although the present embodiment is directed at a method of capturing medical information with respect to a surgical replacement procedure, medical information may also be captured in this manner for other medical procedures.

Once an individual has been selected as a candidate for joint replacement surgery (step 100), demographic information on the candidate is required (step 102). This demographic information is generally obtained from an existing patient file. The demographic information includes items such as name, address, sex and health card number. Other information relating to consultation information resulting from appointments between the candidate and the medical practitioner may also be collected. In order to correlate this patient information (demographic and consultation), a medical information record is created for the patient and stored within a database structure on the computer 12. The patient information is then entered into the computer 12 and stored as part of the medical information record (step 104). After the patient information has been stored in the medical information record, a flag is set for the record to indicate that the operation information has not been stored. While the patient information is being entered into the medical information record, data checks are performed to check whether or not the information being entered is valid. For instance, the operation date for a patient can not be before the consultation date between the patient and the medical practitioner. Within the computer 12, all medical information records are stored in the medical information record database. The storing of operation information for the medical information record is discussed in more detail below.

In the present embodiment, after the patient information has been entered into the computer 12 and stored as part of a medical information record, selected medical information records may be transferred to the PDA 14, as required, so that the medical information record for a patient may be updated during a medical procedure. The PDA 14 is synchronized with the computer 12, via the cradle 20 and cable 22, and the medical information record is then transferred to the PDA 14 (step 106). Although referred to in the singular, it will be understood that more than one medical information record may be transferred during this synchronization process. It is assumed that both the computer 12 and PDA 14 include software to facilitate communication along with compatible software modules which allow the medical information record to be stored on both devices.

During synchronization between the computer 12 and PDA 14, the following steps are performed to transmit information between the computer 12 and the PDA 14. After the computer 12 and the PDA 14 are synchronized using an active synch application program interface (API), such as Microsoft™ ActiveSync, the medical information record database stored on the PDA 14 is retrieved by the computer 12 and used to update the medical information records stored on the computer 12. Initially, the PDA 14 does not have any medical information records stored within its database, however, the synchronization still retrieves the empty database.

The medical information records stored on the computer 12 which do not include operation information are then stored to the PDA medical information database. The updated PDA medical information record database is then transmitted back to the PDA 14 to be stored so that the operation information for each medical information record may be entered.

At times, there may be no medical information record transferred from the computer 12 to the PDA 14 since there are no patients awaiting medical procedures. Similarly, there may be times when no medical information record is transferred from the PDA 14 to the computer 12 if no medical procedures have been performed since the last synchronization.

After the medical information record database has been restored on the PDA 14, the PDA 14 may be transported to an operating room to store operation information for the medical information record of the patient. Prior to capturing the operation information, the scanner 28 must be inserted into the port 26 of the PDA 14.

Upon entering the operating room, the medical information record of the patient is XI retrieved from the PDA 14 so that replacement part information may be scanned and stored to the patient's medical information record (step 108). The replacement part information, such as a catalogue number and/or a lot number, is scanned from bar codes associated with the replacement part or parts to be implanted into the patient.

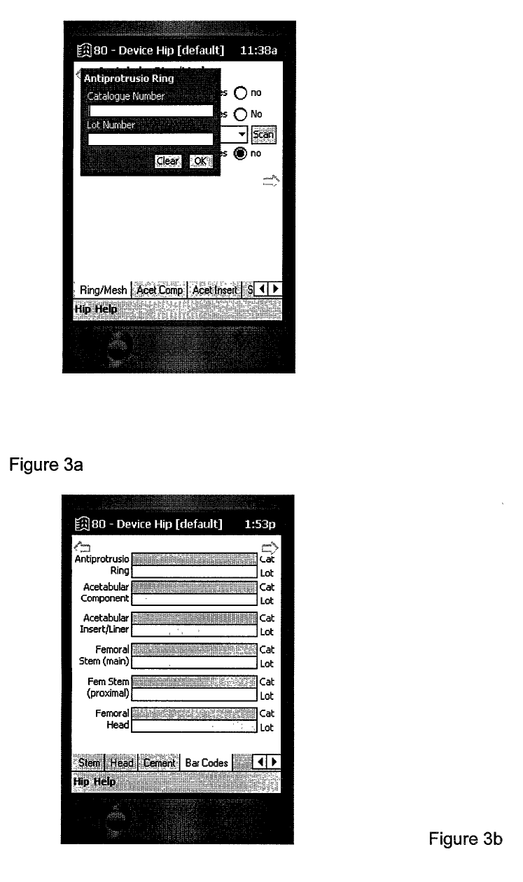

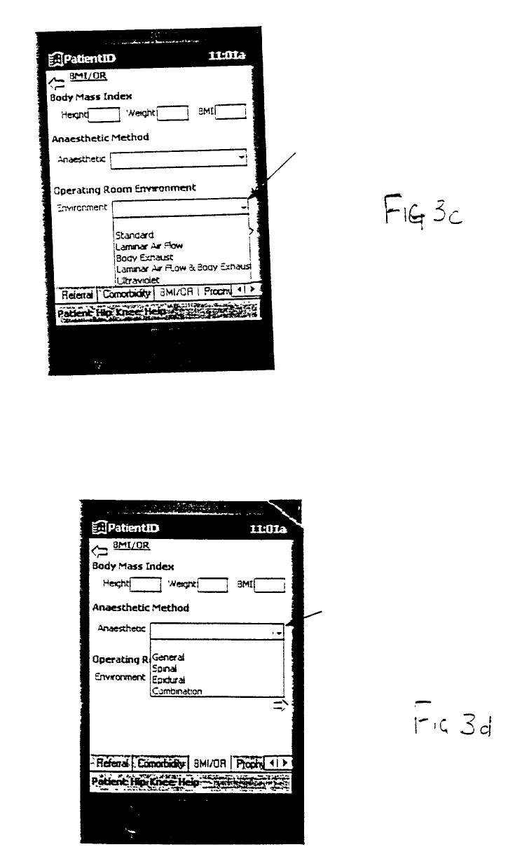

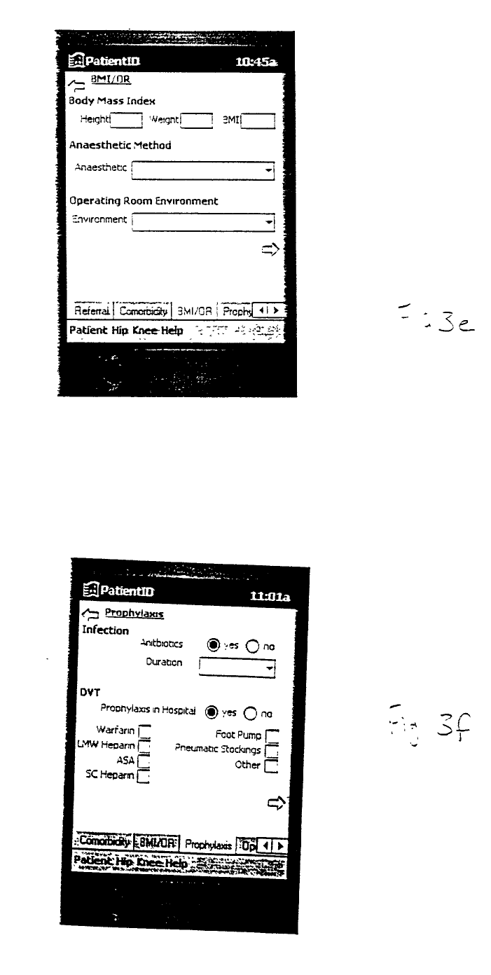

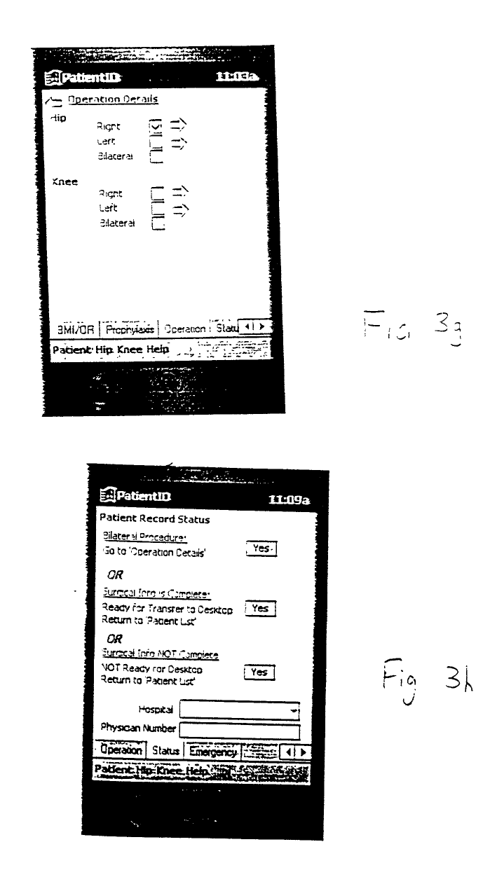

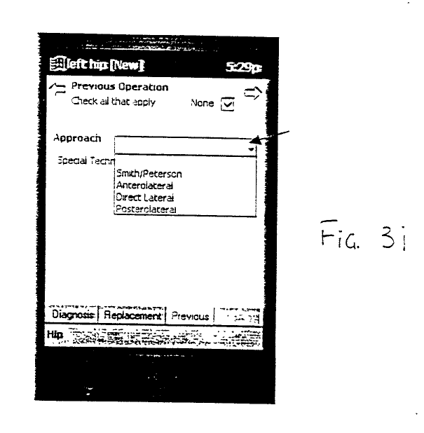

In order to scan the replacement part information, a scanning information screen 206, such as the one shown in FIG. 3a, is preferably used. A cursor preferably appears within a catalogue number text box 212, and if not, the medical practitioner may simply place the cursor within the catalogue number text box 212 by selecting it. The catalogue number bar code of the replacement part is then scanned to retrieve the catalogue number. Use of a PDA scanner to scan bar codes will be well understood by one skilled in the art. After placing the cursor into a lot number text box 214, the medical practitioner may then scan the lot number bar code. After being scanned, the replacement part information is then immediately stored in the medical information record of the patient. Turning to FIG. 3b, it will be understood that more than one replacement part may be implanted and therefore this scanning process may be performed numerous times until all replacement part information is scanned and stored in the patient's medical information record.

Besides replacement part information, surgery information, such as the operating room environment (FIG. 3c), anaesthetic used (FIG. 3d), Body Mass Index (FIG. 3e) or antibiotics used (FIG. 3f) may be entered and stored as well in the medical information record (step 110). The type of surgery which is being performed may also be stored (FIGS. 3g and 3h) along with the type of approach such as Smith/Peterson, anterolateral, direct lateral or posterlateral (FIG. 3i). In order to verify the information being stored, data checks are constantly performed to ensure valid information is being entered. It will be understood that this surgery information may be entered manually by writing the information to the PDA 14 or via drop down selection menus. After the surgery information has been stored, the flag indicating that the operation information has not been stored is cleared.

After the operation information (replacement part and surgery information) has been stored into medical information record, the medical information record is then transmitted back to the to the computer 12 (step 112) via synchronization. After the computer 12 and the PDA 14 are synchronized using Microsoft Active Synch, the medical information record database stored on the PDA 14 is retrieved by the computer 12 using the active synch application program interface (API) and used to overwrite the corresponding medical information records stored on the computer 12.

The medical information records stored on the PDA 14 and the computer 12 both comprise indicators which identify corresponding records so that only those medical information records in the computer medical information record database which correspond to the medical information records retrieved from the PDA medical information record database are overwritten. By checking the indicators, the computer 12 overwrites the medical information records in the computer database which correspond to the records retrieved from the PDA database. In this manner, the medical information records which are stored on the computer medical information record database which have not been transferred to the PDA 14 are not deleted or overwritten by the synchronization process. In order to control the transfer of information and to resolve any ambiguities during the transfer, the PDA 14 has a higher priority than the computer 12.

After the medical information records have been overwritten in the computer medical information records database, the PDA medical information record database is then cleared by the computer 12 and stored with medical information records from the computer medical information record database which require operation information. As discussed above, in order to distinguish between medical information records stored in the computer database which require operation information and those which do not, each medical information record includes a flag which is set until the operation information has been stored. Therefore, only those medical information records in the computer database with their flag set are written to the PDA database.

The updated PDA medical information record database is then transmitted back to the PDA 14 to be stored so that the operation information for the medical information record may be stored.

After the medical information record has been stored on the computer 12, the computer 12 connects to a web site, located on the web server 18, to upload the medical information record to the web server 18 (step 114). As mentioned above, the computer 12 has access to the web site via a connection to the network 24 via a dial-up connection or an Ethernet connection.

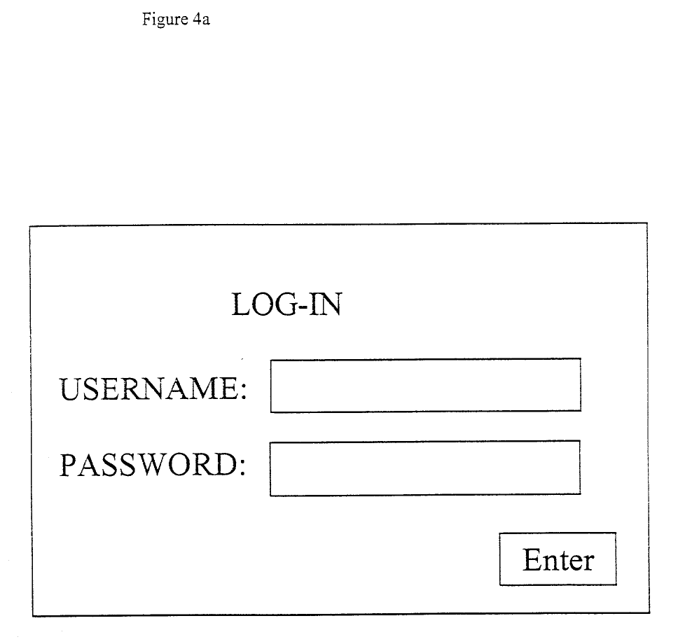

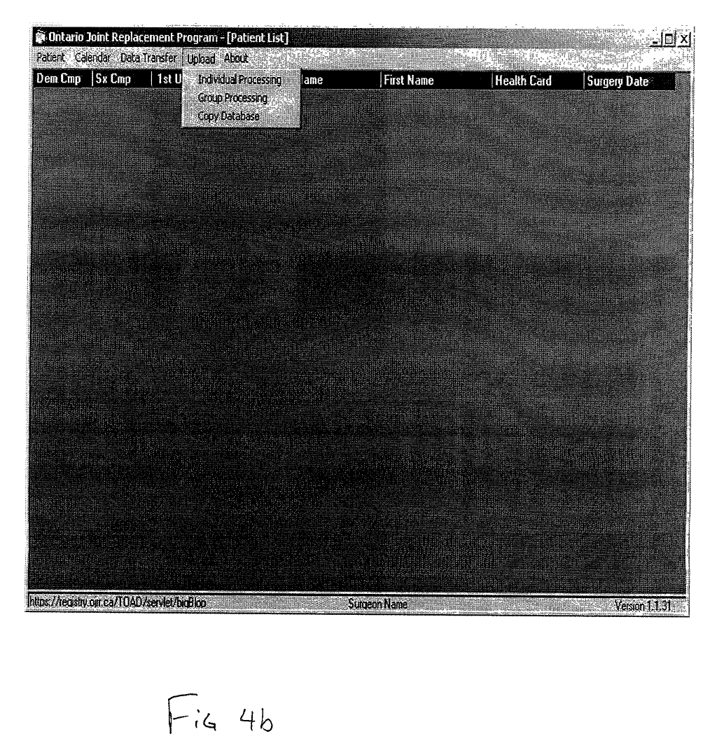

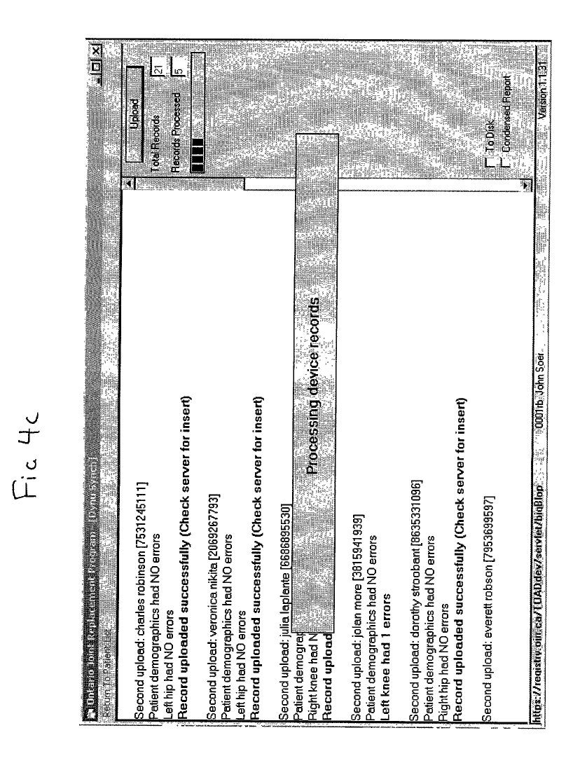

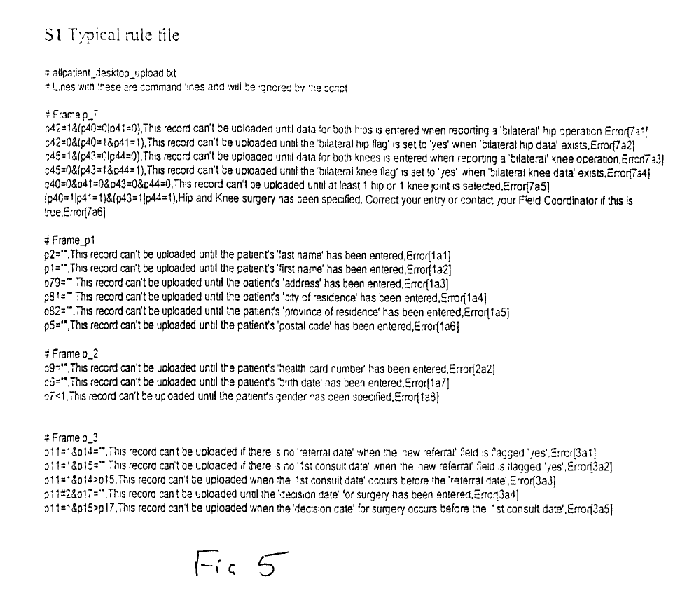

Upon accessing the web site, the medical practitioner is required to log on to the web site. This may be achieved via known login procedures such as requiring a username and password as shown in FIG. 4a. By requiring this validation, security for the practitioner's medical information records is provided. Therefore, others may not access a practitioner's medical information records unless they have the username and password of the practitioner. After being validated, the medical practitioner, or qualified authorized assistant, may then upload the medical information record to the web server 18. A screen shot of an uploading page is shown in FIG. 4b. The medication practitioner, or their assistant, may then select from the upload menu 220 to upload a single medical information record (by selecting the Individual Processing option 222), a group of medical information records (by selecting the Group Processing option 224) or the entire computer medical information record database (by selecting the Copy Database option 226). In each case, the medical information records are individually uploaded from the computer 12 to the web server 18. In order to maintain the privacy of the medical information record being uploaded to the web site, the medical information record is preferably transmitted using https (128-bit encryption). The medical information records are then temporarily stored in the central database within the web server 18. The login provides security so that a medical practitioner only has access to their own medical information records.

During the step of uploading the medical information record, the following steps are performed. Firstly, the medical information record is verified to ensure that it meets predetermined uploading criteria by comparing the information stored within the medical information record with a series of data checks. The data checks are preferably stored in a separate text file so that the text file may be updated without having to affect the uploading process. The data checks contain conditions which the medical information record is required to meet in order to be deemed a valid medical information record. A sample data check file is shown in FIG. 5. After selecting the medical information record to be uploaded, the text file is called by a program which reads in the text file, parses each data check, executes the data check and determines if the data check fails or succeeds. If it is determined that a data check failure exists, the medical practitioner must then correct the error and attempt to upload the medical information record again.

When the medical information record is deemed valid, it is placed into an HTTP format by a software program such as Microsoft Access. The formatted medical information record is then transmitted from the computer 12 to the web server 18 using secure protocol. If the upload is successful, a message is sent to the computer 12 confirming receipt of the medical information record. After the web server 18 receives the medical information record, the medical information record is stored. The medical information record may be once again verified and processed before being transmitted to and stored in the secure database 32 (step 116).

Once the medical information records are stored on the secure database 32, they are preferably only available as read-only data.

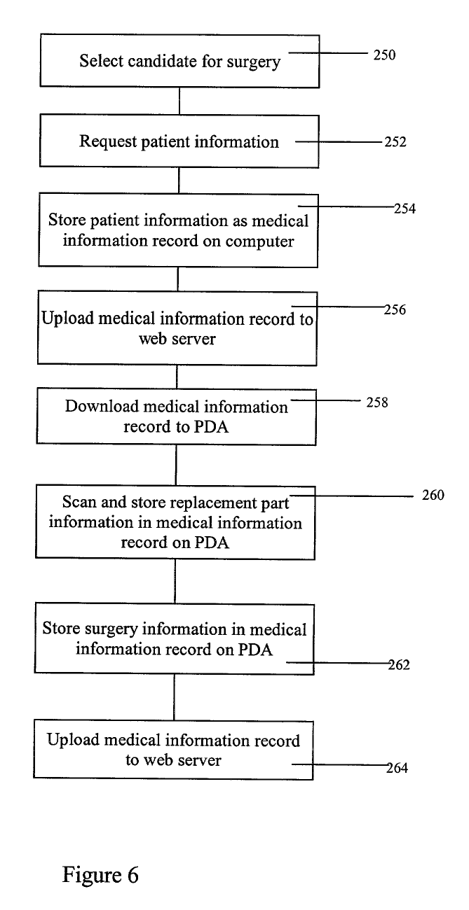

Turning to FIG. 6, a second embodiment of a method of the present invention is shown. As before, a candidate for joint replacement surgery (step 250) is approved and demographic information associated with the candidate is collected so that a medical information record for the candidate, now patient may be created. This information is generally obtained from an existing patient file (step 252). The demographic information is then entered into the medical information record (step 254). Along with the demographic information, consultation information relating to appointments between the medical practitioner and the patient may also be stored as part of the medical information record. After the medical information record has been stored in the computer 12, a flag is set to indicate that the operation information for the medical information record has not been stored. The medical information record is then uploaded to the web server 18 via a web site (step 256). Once again, it is assumed that the computer 12 has access to the web site on the web server 18 either via an Ethernet or a dial-up connection to the network 24.

After the medical practitioner has accessed the web site, the practitioner is required to log on to the web site. This may be in the form of a username and password. The medical practitioner, or their authorized assistant submits the usernane and password to the web server 18 which then confirms that the username and password are valid. After being validated, the medical practitioner may upload the medical information record to the web server 18 for storage. The medical information record is uploaded from the computer 12 to the web server 18 in the same manner as described with respect to FIG. 2. The data checks performed on the partially completed medical information record do not involve checks on the operation information. The medical information record remains on the web server 18 until the PDA 14 accesses the web server 18 to download the medical information record prior to surgery.

In order for the PDA 14 to access the web site, the modem 30 is slotted into the port 26 of the PDA 14 to communicate with the web server 18 via a direct dial-up connection to the web server 18 or via an Internet Service Provider (ISP). The medical practitioner then accesses the web site using a web browser such as Internet Explorer. A validation of the medical practitioner is then performed before the medical practitioner is provided access to his/her medical information records. As discussed above, this may be in the form of a login screen with required username and password. This provides security so that other individuals may not retrieve the medical information records associated with the medical practitioner from the web server 18. The medical information records with flags set are then downloaded to the PDA 14 (step 258) and the medical information record database of the PDA updated. This information transfer is performed via https using the API of the wininet.dll on the PDA. After the medical information record has been stored on the PDA 14, the connection between the PDA 14 and the web server 18 is terminated and the modem 30 is replaced by the scanner 28 in order to prepare the PDA 14 for the retrieval of the operation information for the medical information record.

Prior to the operation, the medical information record of the patient is accessed on the PDA 14 so that the replacement part information may be scanned and stored (step 260) and the surgery information stored (step 262) into the corresponding medical information record. This scanning and storing is performed in the same manner as described above with respect to FIG. 2. After the replacement part information has been stored, the surgery information may then be entered into the PDA 14 and stored in the patient's medical information record. It will be understood that the surgery information may also be stored in the PDA 14 prior to the scanning and storing of the replacement part information. After the operation information has been added to the medical information record, the flag is cleared and the scanner 28 is once again replaced by the modem 30 so that the PDA 14 may upload the medical information record to the web server 18 (step 264). Once again, the PDA 14 connects to the web server 18 via the network 24. The medical information record is then uploaded to the web server 18 and is generally transmitted in predetermined information clusters, or parts. Data checks are performed on each of the information clusters to ensure that the stored information is valid. Each of the parts include a unique ID so that after all the parts have been uploaded, the web server 18 may recombine the parts to form the medical information record. After the entire medical information record has been recombined, the web server 18 sends a signal to the PDA 14 to confirm the upload. The PDA 14 then updates its medical information record database by removing the transmitted medical information record. The medical information record is then processed before being transmitted to the secure database 32.

As will be understood, when dealing with medical information, there is a required privacy for such information. Therefore, in order to maintain safe and secure transfer, storage and maintenance of the medical information records, the following safeguards are preferably used.

The PDA medical information record database is password protected so that it is secured against hacking and snooping. Therefore, access to the medical information records stored on the PDA 14 is restricted to those who know the password such as the medical practitioner. If there is an attempt at an unauthorized unlocking of the PDA 14, the PDA 14 resets and the medical information records are purged from memory. This will be understood as an inherent property of a PDA. Those with access to the password are also required to sign agreements requiring them to safeguard the password.

With the transmission of the information from the computer 12 to the PDA 14 and vice versa, the use of a direct cable connection provides security to the records. With respect to security on the computer 12, the medical information record database is an encrypted database such that if the database is copied, the database is unusable to the person who copied the database. This medical information record database is also password protected.

When the record is stored on the web server 18, which is preferably a dedicated server with firewall, medical practitioners are restricted from using unsecured programs such as File Transfer Protocol (FTP) or Telnet to transmit or retrieve medical information records. All communications between the PDA 14 or the computer 12 with the web server 18 are via encrypted Secure Sockets Layer (SSL) communication and Secure Shell (SSH) communications. Also, once the medical information records have been processed, they are automatically transferred to the secure database 32 for storage.

Furthermore, only registered medical practitioners may access the web site hosted by the web server 18 and, as discussed, must be validated prior to being provided access to the web site. When viewing the medical information records, medical practitioners are only allowed to view the medical information records of their own patients and are restricted access to other medical information records submitted by other medical practitioners since their login access allows them to view only their records. Medical practitioners may be defined as surgeons or their authorized assistants. Finally, only specified individuals are provided with the access codes to both the web server 18 and the secure database 32 in order to manage the records and also perform maintenance on the web server 18 and secure database 32.

In an alternative embodiment, medical information records may be created by the PDA 14 such that all patient information may be directly entered into the PDA 14. The entering of text into a PDA will be well understood by one skilled in the art.

Since the PDA is relatively lightweight and may be easily transported by a single individual between the operating room and the practitioner's office, this provides a portable means to capture the operating information and to immediately store the information in a medical information record corresponding to the patient. In this manner, the chance of human error is reduced. Medical information records are also more portable.

Furthermore, if the selected candidate does not have a previously created patient file, the demographic information may be collected by having the candidate fill out a questionnaire.

It will be understood that the scanning and storing of the operation information does not have to occur in the operating room and is simply performed immediately following surgery.

Although the invention has been described with reference to certain specific embodiments, various modifications thereof will be apparent to those skilled in the art without departing from the spirit and scope of the invention as outlined in the claims appended hereto.

The embodiments of the invention in which an exclusive property or privilege is claimed are defined as follows:

1. A method of capturing medical information associated with a patient experiencing a medical procedure comprising the steps of:
storing a first set of information relating to said patient on a PDA;
scanning and storing a second set of generating during said medical procedure on said PDA; and
associating said second set of information with said first set of information and storing said first and second sets of information in a medical information record.

2. The method of claim 1 further comprising, before said step of storing said first set of information, the steps of:
storing said first set of information on a computer; and
transmitting said first set of information from said computer to said PDA.

3. The method of claim 2 wherein said first set of information is patient information.

4. The method of claim 3 wherein said patient information comprises demographic information and consultation information.

5. The method of claim 4 wherein said step of transmitting said first set of information comprises the steps of:
synchronizing said computer and said PDA for communication;
selecting said first set of information stored on said computer;
transferring said selected first set of information from said computer to said PDA.

6. The method of claim 1 further comprising the steps of:
uploading said medical information record from said PDA to a central database; and
storing said medical information record on said central database.

7. The method of claim 6 further comprising the steps of:
transmitting said medical information from said central database to a secure database; and
storing said medical information record on said secure database.

8. The method of claim 6 wherein said step of transmitting said medical information record from said PDA to said central database comprises the steps of:
transmitting said medical information record from said PDA to a computer;
uploading said medical information record from said computer to said central database.

9. The method of claim 6 wherein said step of uploading said medical information record from said PDA to said central database comprises the step of:
establishing a communication channel between said PDA and said central database;
selecting said medical information record stored on said PDA;
uploading said selected medical information record from said PDA to said central database over said communication channel.

10. The method of claim 1 wherein said second set of information is replacement part information.

11. The method of claim 1 further comprising, before said step of storing said first set of information, the steps of:
storing said first set of information on a computer;
uploading said first set of information to said central database;
storing said first set of information on said central database; and
downloading said first set of information from said central database to said PDA.

12. A method of capturing medical information using a PDA having pre-stored patient information in a medical information record comprising the steps of:
scanning, with said PDA, replacement part information associated with said patient; and
storing said replacement part information with said patient information in said medical information record.

13. The method of claim 12, further comprising the steps of:
storing said medical information record on a central database.

14. A method of capturing medical information comprising the steps of:
storing non-scannable information onto a PDA in the form of a medical information record;
scanning and storing scannable information to said medical information record.

15. The method of claim 14 further comprising the step of uploading said medical information record from said PDA to a central database.
